(19) United States
(12) Patent Application Publication
(10) Pub. No.: US 2023/0011763 A1
(43) Pub. Date: Jan. 12, 2023

(54) GESTURE DETERMINING METHOD AND ELECTRONIC DEVICE

(71) Applicant: ASUSTeK COMPUTER INC., Taipei (TW)

(72) Inventors: Shih-Chieh Liao, Taipei (TW); Chin-Hao Chang, Taipei (TW); Shih-Chuan Chiu, Taipei (TW); Yi-Nan Lee, Taipei (TW); Chia-Hao Kang, Taipei (TW); Wei-Cheng Chen, Taipei (TW); Tzu-Hung Chuang, Taipei (TW)

(21) Appl. No.: 17/844,126

(22) Filed: Jun. 20, 2022

(30) Foreign Application Priority Data
Jul. 9, 2021 (TW) 110125406

(51) Int. Cl. G06F 3/04883; G06F 3/041; G09G 5/00

(52) U.S. Cl. CPC G06F 3/04883; G06F 3/04186; G09G 5/003; G06F 3/0412

(57) ABSTRACT

The present application provides a gesture determining method and an electronic device. The gesture determining method includes: sensing a control gesture through at least one motion sensor, and correspondingly generating sensing data; sequentially segmenting the sensing data into a plurality of streaming windows according to a unit of time, each streaming window including a group of sensing values; determining whether a sensing value in a streaming window is greater than a critical value, and triggering subsequent gesture recognition when the sensing value is greater than the critical value; and performing a recognition operation on the streaming window by using a gesture recognition model to consecutively output a recognition result; and determining whether the recognition result meets an output condition, and outputting a predicted gesture corresponding to the recognition result when the recognition result meets the output condition.

### CROSS-REFERENCE TO RELATED APPLICATION

This application claims the priority benefit of Taiwan Application Serial No. 110125406, filed on Jul. 9, 2021. The entirety of the above-mentioned patent application is hereby incorporated by reference herein and made a part of the specification.

### BACKGROUND OF THE INVENTION

### Field of the Invention

The present application relates to a gesture determining method and an electronic device for executing the gesture determining method.

### Description of the Related Art

A mobile device is usually controlled by touching a screen by hand or by voice. In addition to the above-mentioned two methods, more and more functions are implemented through gesture movement to control a mobile device, making it more convenient for a user to use the mobile device.

In existing methods, for motion-sensing gestures collected by sensing, each motion-sensing gesture sensed by a sensor is manually observed, and rules are written into a control component, to recognize the motion-sensing gestures according to the rules. However, when more motion-sensing gestures are to be added, the above-mentioned written rules may become excessively complex, resulting in a decrease in the accuracy of recognition according to the rules. Furthermore, in most cases, when a user turns around, stands up, sits down or performs another action to change a posture, the user may be not using a motion-sensing gesture. A highly sensitive sensor produces numerical changes based on such actions, leading to unnecessary recognition and operation.

### BRIEF SUMMARY OF THE INVENTION

According to the first aspect, a gesture determining method applied to an electronic device is provided. The gesture determining method includes: sensing a control gesture through at least one motion sensor, and correspondingly generating sensing data; sequentially segmenting the sensing data into a plurality of streaming windows according to a unit of time, each streaming window including a group of sensing values; determining whether a sensing value in a streaming window is greater than a critical value, and triggering subsequent gesture recognition when the sensing value is greater than the critical value; and performing a recognition operation on the streaming window by using a gesture recognition model to consecutively output a recognition result; and determining whether the recognition result meets an output condition, and outputting a predicted gesture corresponding to the recognition result when the recognition result meets the output condition.

According to the second aspect, an electronic device is provided. The electronic device senses a control gesture through at least one motion sensor and correspondingly generates sensing data. The electronic device includes a processor, signal-connected to a motion sensor and embedded with a gesture recognition model. The processor sequentially segments the sensing data into a plurality of streaming windows according to a unit of time, each streaming window including a group of sensing values; the processor determines whether a sensing value in a streaming window is greater than a critical value, and when the sensing value is greater than the critical value, performs a recognition operation on the streaming window by using the gesture recognition model to consecutively output a recognition result; and then the processor determines whether the recognition result meets an output condition, and outputs a predicted gesture corresponding to the recognition result when the recognition result meets the output condition.

In summary, the present application provides a highly accurate gesture determining method, and before a sensing value is used for a gesture recognition operation, it is first determined whether the sensing value is the beginning of a control gesture, so as to effectively avoid unnecessary operations, save system resources and energy, and provide a user with better gesture control.

For other functions of the present application and detailed content of embodiments, descriptions are provided below with reference to the accompanying drawings.

### BRIEF DESCRIPTION OF THE DRAWINGS

To describe the technical solutions in the embodiments of the present application or the related art more clearly, the following briefly describes the accompanying drawings required for describing the embodiments or the related art. Apparently, the accompanying drawings in the following description show only some embodiments of the present application, and a person of ordinary skill in the art may derive other drawings from the accompanying drawings without creative efforts. To describe the technical solutions of the embodiments of the present application or the existing technology more clearly, the following briefly introduces the accompanying drawings required for describing the embodiments or the existing technology. Apparently, the accompanying drawings in the following description show only some embodiments recorded in the present application, and a person of ordinary skill in the art still derives other drawings from these accompanying drawings without creative efforts.

FIG. 1 is a schematic block diagram of an electronic device according to an embodiment of the present application;

FIG. 2 is a schematic flowchart of a gesture determining method according to an embodiment of the present application;

FIG. 3 is a schematic flowchart of training a gesture recognition model according to an embodiment of the present application;

FIG. 4 is a schematic diagram of generating a training window by performing random number sampling according to an embodiment of the present application;

FIG. 5 is a schematic structural diagram of a gesture recognition model according to an embodiment of the present application; and

FIG. 6 is a schematic block diagram of an electronic device and a remote control joystick connected to the electronic device according to another embodiment of the present application.

### DETAILED DESCRIPTION OF THE EMBODIMENTS

The positional relationship described in the following embodiments includes: up, down, left, and right, and unless otherwise specified, all are based on directions shown by components in drawings.

In the present application, a gesture recognition model using artificial intelligence (AI) is used, to output a predicted gesture determined by using the gesture recognition model according to a control gesture. The control gesture described herein is a gesture that drives an electronic device or a remote control joystick to rotate, flip, move or perform another action. A value read by a motion sensor on the electronic device or the remote control joystick is provided to the gesture recognition model for recognition.

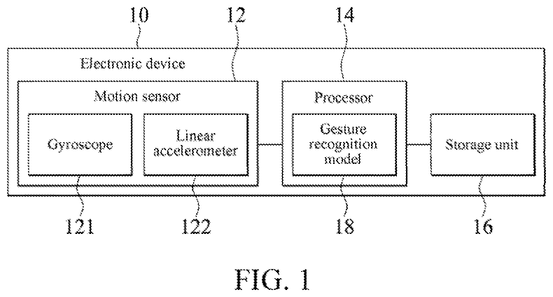

FIG. 1 is a schematic block diagram of an electronic device according to an embodiment of the present application. Referring to FIG. 1, an electronic device 10 includes at least one motion sensor 12, a processor 14, and a storage unit 16. In this embodiment, two motion sensors 12 are used as an example, and are a gyroscope 121 and a linear accelerometer 122 for separately sensing a control gesture and correspondingly generating sensing data. The control gesture herein is a gesture that drives the electronic device 10 to rotate, flip, move or perform another action. The processor 14 is electrically connected to the motion sensor 12 to receive the sensing data generated by the gyroscope 121 and the linear accelerometer 122. The processor 14 is embedded with a gesture recognition model 18. The processor 14 preprocesses the sensing data and performs a recognition operation through the gesture recognition model 18, so that the gesture recognition model 18 consecutively outputs a recognition result, and the processor 14 generates a corresponding predicted gesture based on at least two consecutive identical recognition results. The processor 14 is enabled to perform a system operation corresponding to the predicted gesture, for example, launching a user interface or an application program. The storage unit 16 is electrically connected to the processor 14 for storing operation data or data required by the processor 14.

In an embodiment, the electronic device 10 is a mobile electronic device such as a mobile phone, a personal digital assistant (PDA), a mobile multimedia player or any type of portable electronic product. The present application is not limited thereto.

In an embodiment, the gesture recognition model 18 is a convolutional neural network (CNN) model.

Based on the electronic device 10, the present application further provides a gesture determining method, applicable to the electronic device 10. Steps of the gesture determining method are described below in detail in conjunction with the electronic device 10.

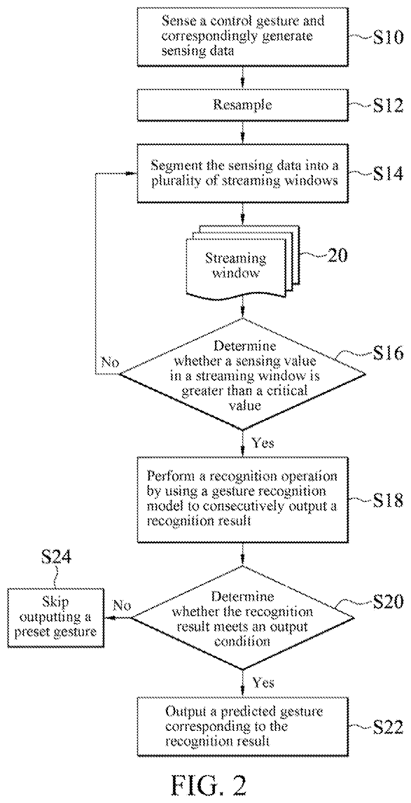

Referring to both FIG. 1 and FIG. 2, a gesture determining method is applicable to an electronic device 10. A control gesture drives the electronic device 10 to rotate, flip, move, or perform another action to change a position in space. The gesture determining method includes the following steps. As shown in step S10, the motion sensor 12 senses the control gesture to correspondingly generate sensing data, and transmits the sensing data to the processor 14. As shown in step S12, after receiving the sensing data, the processor 14 resamples the sensing data. When a sampling frequency of the sensing data is excessively high, the processor 14 down-samples the sensing data to avoid affecting a response time. When the sampling frequency of the sensing data is excessively low, the processor 14 up-samples the sensing data to avoid affecting the accuracy of determining. In an embodiment, when the sampling frequency of the sensing data is appropriate or the sampling frequency is not taken into consideration, Step S12 may be omitted.

As shown in step S14, according to a unit of time, resampled sensing data is sequentially segmented into a plurality of streaming windows 20 that overlap each other. Each streaming window 20 includes a group of sensing values (for example, readings of an X-axis, a Y-axis, and a Z-axis). Each streaming window 20 is a piece of data that is subsequently read by the gesture recognition model 18 for recognition and determining. Next, as shown in step S16, the processor 14 determines whether a sensing value in a streaming window 20 is greater than a critical value, and triggers subsequent gesture recognition when the sensing value is greater than the critical value (step S18). When the sensing value is not greater than the critical value, the subsequent gesture recognition is not triggered, and determining continues to be performed for a next streaming window 20. Step S16 is used to avoid unnecessary operations. That is, in most cases, even when a user does not use a control gesture, but simply turns around, stands up, sits down or performs another action to change a posture, the motion sensor 12 still generates a change in value. Therefore, the critical value is set. When a sensing value is greater than the critical value, it is determined that the sensing value is the beginning of the control gesture, and subsequent sensing values are all transmitted to the gesture recognition model 18 for recognition.

As shown in step S18, the processor 14 uses the gesture recognition model 18 to perform the recognition operation on the streaming window 20 to consecutively output a recognition result. A plurality of preset gestures is embedded in the gesture recognition model 18. Each recognition result includes each preset gesture and a probability value of the preset gesture. Therefore, the gesture recognition model 18 consecutively outputs probability values of all default gestures corresponding to each streaming window 20 according to the consecutive streaming windows 20.

As shown in step S20, the processor 14 determines whether the recognition result meets an output condition. The output condition is that the gesture recognition model 18 consecutively outputs at least two identical recognition results, and outputs a predicted gesture corresponding to the recognition result when the recognition result meets the output condition, as shown in step S22. When the recognition result does not meet the output condition, as shown in step S24, the preset gesture is not outputted. Because a control gesture has a plurality of consecutive streaming windows 20, the gesture recognition model 18 correspondingly generates the same quantity of recognition results. In a plurality of consecutive recognition results, a determining strategy is needed to determine whether to output the preset gesture. In an embodiment, the processor 14 uses a preset gesture corresponding to the highest probability value as a recognition result for determining whether the output condition is met. For example, when the preset gestures corresponding to the highest probability values in two consecutive recognition results are the same gesture, it means that the output condition is met. Therefore, the preset gesture is outputted as the predicted gesture, and the processor 14 executes a system operation corresponding to the predicted gesture. In contrast, when the preset gestures corresponding to the highest probability values in two consecutive recognition results are different gestures, it means that the output condition is not met, and the preset gesture is not outputted in this case.

In the present application, before the electronic device 10 uses the gesture recognition model 18 to perform gesture determining, the electronic device 10 first performs pre-training on the gesture recognition model 18. That is, a neural network is first trained with a large amount of training data to optimize all parameters in the gesture recognition model 18.

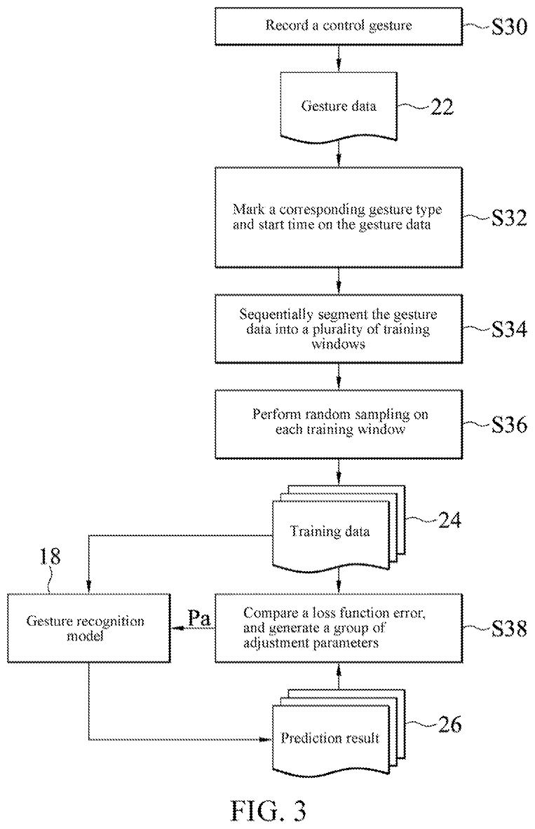

Referring to both FIG. 1 and FIG. 3, a method for training a gesture recognition model by the processor 14 further includes step S30 to step S38. As shown in step S30, a user holds the electronic device 10 and performs a control gesture. The control gesture is recorded to obtain a corresponding gesture data 22 (the sensing value) through the motion sensor 12 (the gyroscope 121 and the linear accelerometer 122). As shown in step S32, a corresponding gesture type, start time, and end time are marked on the gesture data 22. Next, based on the gesture data 22, a plurality of pieces of training data 24 is correspondingly generated. The step of generating the training data 24 includes step S34 and step S36.

As shown in step S34, the processor 14 sequentially segments the gesture data 22 into a plurality of training windows that overlap each other. In an embodiment, for each piece of marked gesture data 22, a fixed-length sliding window is used to sequentially extract training windows that overlap each other. Each training window is used as one piece of training data 24. For example, there are M sampling points in the gesture data 22. The size of the sliding window is set to N sampling points. N is less than M. At least half of the gestures need to be covered. M−N+1 training windows may be taken by stepping through the M sampling points in the gesture data 22 one by one through the sliding window.

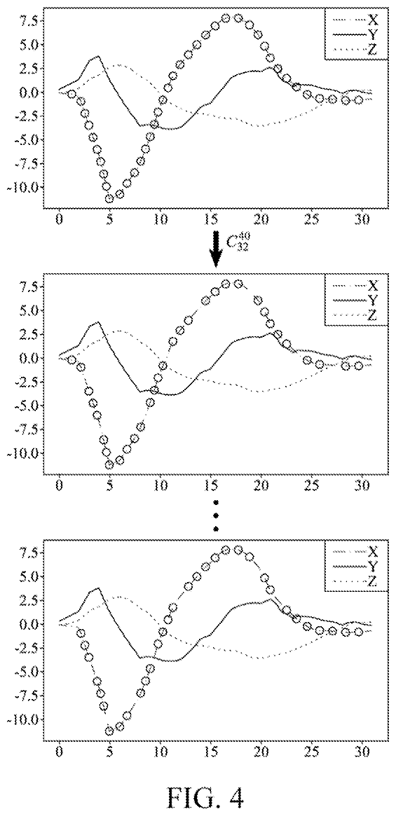

As shown in step S36, random sampling is performed on each training window to generate more training data 24. Because a quantity of training windows generated from the marked gesture data 22 is limited, to increase the amount of training, in the present application, step S36 is used to effectively increase the training data 24. Originally, M−N+1 training windows are generated from the gesture data 22. In the present application, any N sampling points selected from the M sampling points are used as a new training window to increase the training data 24. In an embodiment, as shown in FIG. 4, assuming that there are a total of 40 sampling points in one piece of gesture data 22, the training model requires a window with 32 sampling points. Therefore, random sampling may be performed on 40 sampling points to randomly select 32 sampling points as a new training window. A total of 76,904,685 different training windows are extracted as the training data 24, and the gesture recognition model 18 of the present application is trained through a large amount of training data 24, to obtain a better training effect.

Referring to FIG. 1 and FIG. 3, these training data 24 are sequentially inputted into the gesture recognition model 18 for recognition. The gesture recognition model 18 consecutively outputs a prediction result 26 according to each piece of training data 24. Then, as shown in step S38, a loss function error between the prediction result 26 outputted by the gesture recognition model 18 is compared with marked training data 24. Because the marked training data 24 is a known gesture, comparison of the loss function error may be performed on the marked training data 24 and the prediction result 26. According to a comparison result, a group of adjustment parameters Pa are generated and fed back to the gesture recognition model 18 to adjust various parameter settings in the gesture recognition model 18 according to the adjustment parameters Pa. Because there is a large amount of training data 24, the steps of inputting the training data 24, recognizing the gesture recognition model 18, outputting the prediction result 26, comparing in step S38, and feeding back adjustment parameters Pa are consecutively repeated until the outputted prediction result 26 is approximately the same as a gesture marked by the training data 24, to complete the training of the gesture recognition model 18, and optimize parameters in the gesture recognition model 18.

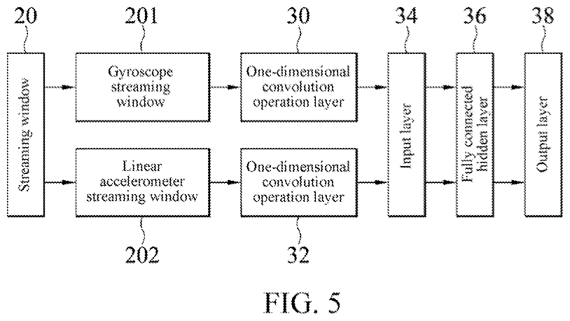

In an embodiment, the gesture recognition model 18 adopts a structure of a CNN. Referring to both FIG. 1 and FIG. 5, the motion sensor 12 having both the gyroscope 121 and the linear accelerometer 122 is used as an example herein. The streaming window 20 in the gesture recognition model 18 inputted by the processor 14 is divided into two paths. One path is a gyroscope streaming window 201, and the other path is a linear accelerometer streaming window 202. The gyroscope streaming window 201 is inputted into a one-dimensional convolution operation layer 30 for preprocessing. The linear accelerometer streaming window 202 is inputted into a one-dimensional convolution operation layer 32 for preprocessing. Each of the one-dimensional convolution operation layer 30 and the one-dimensional convolution operation layer 32 includes at least a one-dimensional convolutional layer and a pooling layer, to perform a convolution operation and pooling dimensionality reduction processing on the gyroscope streaming window 201 and the linear accelerometer streaming window 202, and learn feature points of each streaming window 20. All the learned feature points are correspondingly inputted into a plurality of input nodes in an input layer 34 of a neural network. For example, the feature points of the X-axis, Y-axis, and Z-axis of the corresponding gyroscope streaming window 201 and the feature points of the X-axis, Y-axis, and Z-axis of the corresponding linear accelerometer streaming window 202 are respectively inputted from the input nodes in the input layer 34. A fully connected hidden layer 36 is arranged between the input layer 34 and an output layer 38. The fully connected hidden layer 36 is included in a plurality of hidden layers. The hidden layer has a plurality of hidden layer neural nodes that are fully connected. The output layer 38 has a plurality of output nodes. In this way, the fully connected hidden layer 36 is configured to connect the feature points to the structure of the neural network of control gestures. A quantity of output nodes in the output layer 38 is the same as a quantity of default gestures embedded in the gesture recognition model 18. An output of each output node represents one preset gesture and a probability value corresponding to the preset gesture. The fully connected hidden layer 36 used in the present application uses one to a plurality of layers of hidden layer neural nodes as required, and a quantity of input nodes, a quantity of hidden layer neural nodes, and a quantity of output nodes used herein may be adjusted to any value based on an actual condition. Therefore, an input of the gesture recognition model 18 is a streaming window 20, and an output of the gesture recognition model 18 is a probability distribution of various preset gestures.

In another embodiment, a structure of the gesture recognition model 18 in training is also shown in FIG. 5. A difference lies in that windows inputted into the one-dimensional convolution operation layer 30 and the one-dimensional convolution operation layer 32 are the training windows (the training data). The rest of the structure is the same as that in the foregoing content. Therefore, details are not described again herein. In a training process, in the present application, a gradient descend algorithm is further adopted to optimize a loss function (step S38 shown in FIG. 3) to gradually adjust the parameters of layers in the fully connected hidden layer 36 to optimize the parameters and establish a correlation between an input and an output. The trained gesture recognition model 18 may perform an output prediction of a control gesture according to the inputted streaming window 20.

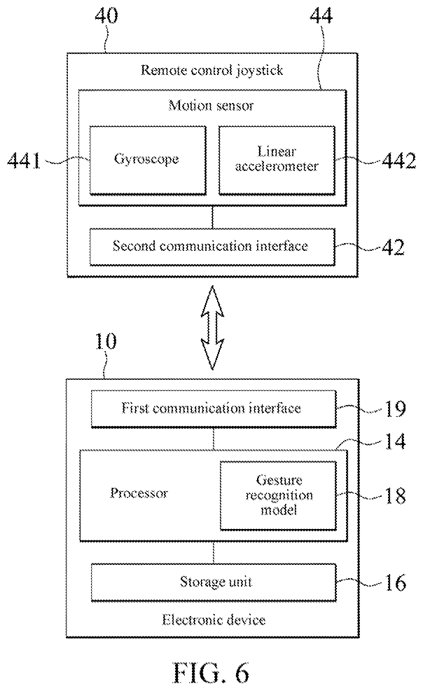

FIG. 6 is a schematic block diagram of an electronic device according to another embodiment of the present application. Referring to FIG. 6, the electronic device 10 includes a processor 14, a first communication interface 19, and a storage unit 16. The processor 14 is electrically connected to the first communication interface 19 and the storage unit 16. The storage unit 16 is configured to store the operation data or the data required by the processor 14. In this embodiment, the electronic device 10 is connected to a remote control joystick 40 in a wired or wireless manner. The remote control joystick 40 includes a second communication interface 42 and at least one motion sensor 44. The motion sensor 44 is electrically connected to the second communication interface 42. Two motion sensors 44 are used as an example herein, and are a gyroscope 441 and a linear accelerometer 442 for separately sensing a control gesture and correspondingly generating sensing data. The control gesture herein is a gesture that drives the remote control joystick 40 to rotate, flip, move or perform another action. The sensing data generated by the motion sensor 44 is transmitted to the electronic device 10 through the second communication interface 42. The second communication interface 42 is connected to the first communication interface 19 in a wired or wireless manner, so that the electronic device 10 is signal-connected to the motion sensor 44 by the first communication interface 19 and the second communication interface 42 to receive the sensing data. After the processor 14 receives the sensing data from the remote control joystick 40 through the first communication interface 19, the processor 14 preprocesses the sensing data and performs the recognition operation through the embedded gesture recognition model 18, so that the gesture recognition model 18 consecutively outputs the recognition result. The processor 14 generates the corresponding predicted gesture according to at least two consecutive identical recognition results. The processor 14 is enabled to perform a system operation corresponding to the predicted gesture, for example, launching a user interface or an application program.

In an embodiment, the electronic device 10 may be a notebook computer, a desktop computer, a mobile phone, a PDA, a mobile multimedia player, or any electronic product with a processor. The present application is not limited thereto.

Based on the embodiments of the electronic device 10 and the remote control joystick 40, the gesture determining method of the present application is also applicable to a combination of the electronic device 10 and the remote control joystick 40. Except that a user holds the remote control joystick 40 to perform the control gestures, the rest of the methods and actions are the same as those in the previous embodiments. For detailed steps and details, refer to the related descriptions of FIG. 2 to FIG. 5. Therefore, details are not described again herein.

In summary, the present application provides a highly accurate gesture determining method, and before a sensing value is used for a gesture recognition operation, it is first determined whether the sensing value is the beginning of a control gesture, so as to effectively avoid unnecessary operations, save system resources and energy, and provide a user with better gesture control.

The foregoing embodiments and/or implementations are merely preferred embodiments and/or implementations used for describing the technologies in the present application, and are not intended to limit implementation forms of the technologies in the present application. A person skilled in the art can make alterations or modifications to obtain other equivalent embodiments without departing from the scope of the technical solutions disclosed in the content of the present application. Such equivalent embodiments shall still be regarded as technologies or embodiments substantially the same as the present application.

What is claimed is:

1. A gesture determining method, applicable to an electronic device, wherein the gesture determining method comprises:
sensing a control gesture through at least one motion sensor, and correspondingly generating sensing data;
sequentially segmenting the sensing data into a plurality of streaming windows according to a unit of time, each streaming window comprising a group of sensing values;
determining whether a sensing value in a streaming window is greater than a critical value, and triggering subsequent gesture recognition when the sensing value is greater than the critical value;
performing a recognition operation on the streaming window by using a gesture recognition model to consecutively output a recognition result; and
determining whether the performing a recognition operation on the streaming window by using a gesture recognition model to consecutively output a recognition result; and recognition result meets an output condition, and outputting a predicted gesture corresponding to the recognition result when the recognition result meets the output condition.

2. The gesture determining method according to claim 1, wherein the control gesture drives the electronic device to change a position in space, and the motion sensor is arranged in the electronic device.

3. The gesture determining method according to claim 1, wherein the control gesture drives a remote control joystick to change a position in space, and the motion sensor is arranged in the remote control joystick.

4. The gesture determining method according to claim 1, wherein the motion sensor is a gyroscope, a linear accelerometer or a combination thereof.

5. The gesture determining method according to claim 1, wherein the streaming windows are windows that overlap each other.

6. The gesture determining method according to claim 1, wherein after the step of generating sensing data, the gesture determining method further comprises resampling the sensing data, and then sequentially segmenting the resampled sensing data into the streaming windows.

7. The gesture determining method according to claim 1, wherein the gesture recognition model is a convolutional neural network (CNN) model.

8. The gesture determining method according to claim 1, wherein the output condition is that the gesture recognition model consecutively outputs at least two identical recognition results.

9. The gesture determining method according to claim 8, wherein a plurality of default gestures is embedded in the gesture recognition model, the recognition result comprises each preset gesture and a probability value of the preset gesture, and a preset gesture corresponding to the highest probability value is used as a recognition result for determining whether the output condition is met.

10. The gesture determining method according to claim 9, wherein when the preset gestures corresponding to the highest probability values in two consecutive recognition results are the same gesture, the output condition is met, and the preset gesture is outputted as the predicted gesture.

11. The gesture determining method according to claim 9, wherein when the preset gestures corresponding to the highest probability values in two consecutive recognition results are different gestures, the output condition is not met, and the preset gesture is not outputted.

12. An electronic device, sensing a control gesture through at least one motion sensor, and correspondingly generating sensing data, wherein the electronic device comprises:
a processor, signal-connected to a motion sensor and embedded with a gesture recognition model to receive the sensing data, wherein the processor sequentially segments the sensing data into a plurality of streaming windows according to a unit of time, each streaming window comprising a group of sensing values; the processor determines whether a sensing value in a streaming window is greater than a critical value, and performs a recognition operation on the streaming window by using the gesture recognition model to consecutively output a recognition result when the sensing value is greater than the critical value; and the processor determines whether the recognition result meets an output condition, and outputs a predicted gesture corresponding to the recognition result when the recognition result meets the output condition.

13. The electronic device according to claim 12, wherein the control gesture drives the electronic device to change a position in space, and the motion sensor is arranged in the electronic device.

14. The electronic device according to claim 12, wherein the control gesture drives a remote control joystick to change a position in space, the motion sensor is arranged in the remote control joystick, and the remote control joystick is connected to the electronic device.

15. The electronic device according to claim 12, wherein the motion sensor is a gyroscope, a linear accelerometer or a combination thereof.

16. The electronic device according to claim 12, wherein the streaming windows are windows that overlap each other.

17. The electronic device according to claim 12, wherein the processor further resamples the sensing data first, and then sequentially segments the resampled sensing data into the streaming windows.

18. The electronic device according to claim 12, wherein the gesture recognition model is a convolutional neural network (CNN) model.

19. The electronic device according to claim 12, wherein the output condition is that the gesture recognition model consecutively outputs at least two identical recognition results.

20. The electronic device according to claim 19, wherein a plurality of default gestures is embedded in the gesture recognition model, the recognition result comprises each preset gesture and a probability value of the preset gesture, and a preset gesture corresponding to the highest probability value is used as a recognition result for determining whether the output condition is met.

21. The electronic device according to claim 20, wherein when the preset gestures corresponding to the highest probability values in two consecutive recognition results are the same gesture, the output condition is met, and the processor outputs the preset gesture as the predicted gesture.

22. The electronic device according to claim 20, wherein when the preset gestures corresponding to the highest probability values in two consecutive recognition results are different gestures, the output condition is not met, and the processor does not output the preset gesture.

23. The electronic device according to claim 12, wherein a method for the processor to train the gesture recognition model further comprises:
recording the control gesture to obtain corresponding gesture data;
marking a corresponding gesture type, start time, and end time on the gesture data;
generating a plurality of pieces of training data according to the gesture data;
sequentially inputting the training data into the gesture recognition model for recognition, the gesture recognition model outputting a prediction result according to each piece of training data; and
comparing a loss function error between the prediction result and the training data, and generating a group of adjustment parameters to be fed back to the gesture recognition model to adjust the gesture recognition model.

24. The electronic device according to claim 23, wherein the step of generating training data by the processor further comprises:
sequentially segmenting the gesture data into a plurality of training windows; and
performing random sampling on each training window to generate more training data.

25. The electronic device according to claim 23, wherein the training windows are windows that overlap each other.
